(19) United States
(12) Patent Application Publication
(10) Pub. No.: US 2012/0127728 A1
(43) Pub. Date: May 24, 2012

(54) LIGHT DISTRIBUTION STRUCTURE FOR LED LIGHT SOURCE

(75) Inventor: SHAO-HAN CHANG, Tu-Cheng (TW)

(73) Assignee: HON HAI PRECISION INDUSTRY CO., LTD., Tu-Cheng (TW)

(21) Appl. No.: 13/083,586

(22) Filed: Apr. 10, 2011

(30) Foreign Application Priority Data
Nov. 18, 2010 (CN) 201010549480.9

(51) Int. Cl. F21V 7/00

(52) U.S. Cl. 362/296.01

(57) ABSTRACT

A light distribution structure for a light emitting diode includes a lens, a light distribution member, and a reflection member. The lens is fixed to the light distribution member. The reflection member is fixed to the lens and faces the light distribution member. The reflection member includes a protrusion opposing the light emitting diode. The light distribution member defines a through hole for receiving the light emitting diode. The light distribution member is formed with a plurality of reflection portions on a side facing the lens. The reflection portions are inclined relative to the bottom of the light distribution member. The protrusion is capable of reflecting the light beams with incident angle within a preset range entering the protrusion from the light emitting diode to the reflection portions. The reflection portions are capable of reflecting the light beams reaching the reflection portions to the lens.

### BACKGROUND

1. Technical Field

The present disclosure relates to light distribution structures, especially to a light distribution structure for LED light sources.

2. Description of Related Art

Compared to traditional light sources, light emitting diodes (LEDs) have many advantages, such as high luminous efficiency, low power consumption, and long service life. LED lights are widely used in many applications. The light emitting diodes are small and have a narrow light emitting angle, thus the light emitting diodes emit light that may be too bright, which can harm people's eyes.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded view of a light distribution structure according to an exemplary embodiment.

FIG. 2 is a cross-sectional view of the light distribution structure in FIG. 1.

FIG. 3 is a schematic view of light paths illustrating light beams emitted by light emitting diode in FIG. 2.

### DETAILED DESCRIPTION

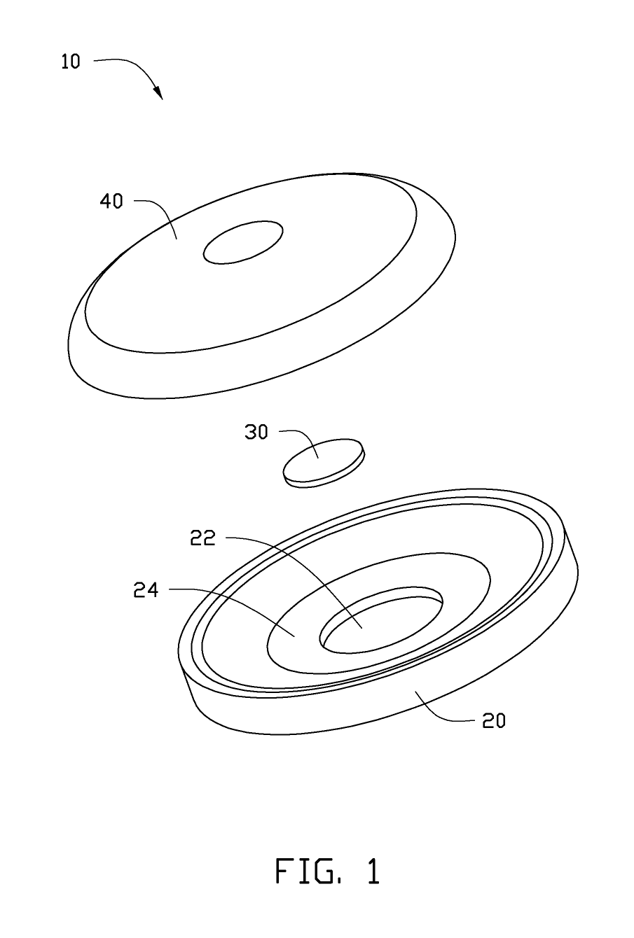

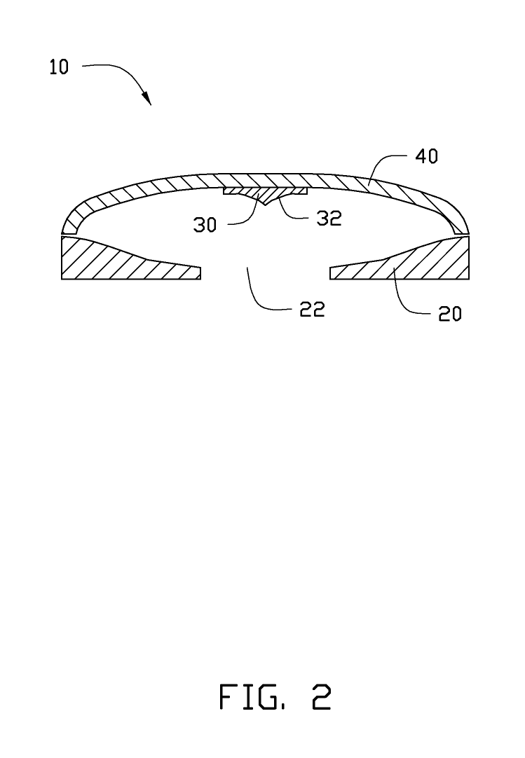

Referring to FIGS. 1 and 2, a light distribution structure 10 according to an exemplary embodiment includes a light distribution member 20, a reflection member 30 and a lens 40. The lens 40 is fixed to the light distribution member 20. The reflection member 30 is fixed to the lens 40 and faces the light distribution member 20.

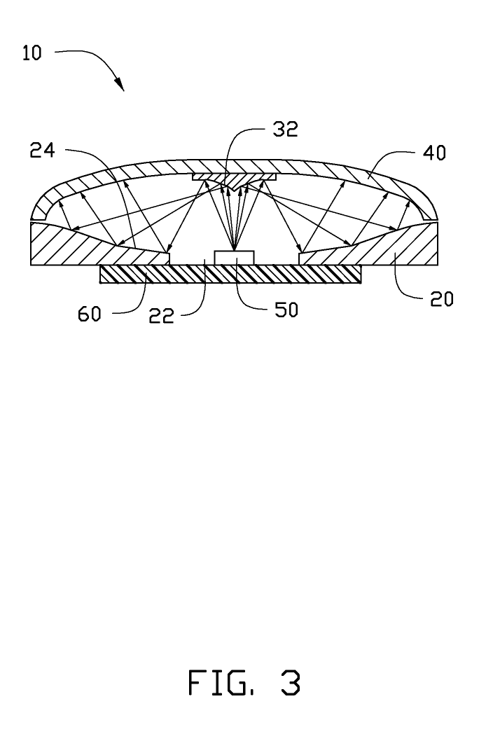

The light distribution member 20 is an approximate flat cylinder. The light distribution member 20 defines a through hole 22 in its center. Referring to FIG. 3, the light distribution member 20 can be fixed to a circuit board 60 with screws (not shown). A light emitting diode 50 is mounted on the circuit board 60. The light emitting diode 50 is received in the through hole 22. The light distribution member 20 is formed with a number of annular reflection portions 24 on a side opposing the lens 40. The reflection portions 24 are inclined relative to the bottom of the light distribution member 20. The reflection portions 24 have different inclinations relative to the bottom of the light distribution member 20. The reflection portions 24 are used for reflecting the light beams from the light emitting diode 50 to the lens 40.

The lens 40 is an approximate plate-shaped. The edge of the lens 40 can be fixed to the edge of the light distribution member 20 with screws (not shown).

The reflection member 30 is fixed to the inner surface of the lens 40. The reflection member 30 is formed with a protrusion 32 opposing the light emitting diode 50. The protrusion 32 is configured for reflecting the light beams with incident angle within a preset range from the light emitting diode 50 to the reflection portions 24.

Referring to FIG. 3, the light beams with incident angle within a preset range reaching the protrusion 32 are reflected to the reflection portions 24. Then the reflection portions 24 reflect the light beams to the lens 40. After being reflected twice, the incident angle of the light beams entering the lens enlarges, so that the light emitting angle of the light beams exiting the lens 40 widens. Because the reflection portions 24 have different inclination, the light beams are better-distributed. Therefore, the light beams become softer.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A light distribution structure for a light emitting diode comprising:
a lens;
a light distribution member; and
a reflection member;
wherein the lens is fixed to the light distribution member, the reflection member is fixed to the lens and faces the light distribution member, the reflection member is formed with a protrusion opposing the light emitting diode, the light distribution member defines a through hole for receiving the light emitting diode, the light distribution member is formed with a plurality of reflection portions on a side facing the lens, the reflection portions are inclined relative to the bottom of the light distribution member, the protrusion is capable of reflecting the light beams with incident angle within a preset range from the light emitting diode to the reflection portions, the reflection portions are capable of reflecting the light beams reaching the reflection portions to the lens.

2. The light distribution structure of claim 1, wherein the reflection portions are annular, and have different inclination relative to the bottom of the light distribution member.

3. The light distribution structure of claim 1, wherein the lens is a plate-shaped, an edge of the lens is fixed to an edge of the light distribution member.
